(19) United States
(12) Patent Application Publication
(10) Pub. No.: US 2023/0036002 A1
(43) Pub. Date: Feb. 2, 2023

(54) DELEGATED AUTHORIZATION VIA SINGLE ACCESS TOKEN

(71) Applicant: Dell Products L.P., Round Rock, TX (US)

(72) Inventors: Joshua M. PENNELL, Kennewick, WA (US); Aniruddha HEREKAR, Bangalore (IN); Hiren Kishorbhai PITRODA, Rajkot (IN); Divya VIJAYVARGIYA, Cedar Park, TX (US); Farhan Mohammed SYED, Bangalore (IN)

(73) Assignee: Dell Products L.P., Round Rock, TX (US)

(21) Appl. No.: 17/385,656

(22) Filed: Jul. 26, 2021

(51) Int. Cl. H04L 9/32; H04L 9/08; H04L 29/08

(52) U.S. Cl. CPC H04L 9/3213; H04L 9/0833; H04L 67/02; H04L 67/1044

(57) ABSTRACT

An information handling system may include a processor; a memory; and a management controller. The information handling system may be configured to: receive, at the management controller and from a client information handling system, a request for management associated with the management controller; determine an audience claim of a token associated with the request, wherein the audience claim comprises a group identifier, and wherein the group identifier is associated with a plurality of management controllers; and in response to a determination that the management controller is one of the plurality of management controllers with which the group identifier is associated, cause the management controller to service the request.

### TECHNICAL FIELD

The present disclosure relates in general to information handling systems, and more particularly to delegated authorization (DA) solutions in information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Delegated authorization (also referred to as “delegated auth” or simply “DA”) refers generally to systems for accessing services such as application programming interfaces (APIs) in a secure manner. Delegated authorization may allow a user to log into a centralized authorization server, which may issue a token such as a JavaScript Object Notation (JSON) Web Token (JWT). The token may then be used in lieu of having a separate username and password for every service that needs to be accessed. Some delegated authorization systems may leverage technologies such as OAuth 2.0, etc.

The addition of delegated authorization may facilitate a scriptable interface, allowing access to individual management controllers and replacing device-specific usernames and passwords with device-specific tokens. The tokens issued by an authorization server or a signing service are specific to an individual management controller, and they specify the privileges of the token owner with respect to that management controller.

One issue with this design is that after a management controller is configured for delegated authorization, it needs access tokens issued specifically for that management controller. The current solution accepts only tokens with an “audience claim” value that matches some unique identifier (e.g., a service tag number or a Media Access Control (MAC) address) of the management controller in question. Thus a given token can be used only for a single management controller. This works acceptably for a small-to-medium business setup. However, while scripting access to a large number of management controllers (e.g. in a datacenter environment), the client application having to exchange an offline token for each individual management controller's access token individually and one at a time can become cumbersome.

The existing solutions may also necessitate that a token database be set up for storing and retrieving offline tokens and access tokens for each management controller. The number of tokens will continue to grow with the number of management controllers being accessed, making the solution difficult to use and creating a scalability problem.

It may be possible to construct a token having an audience claim that includes an array of strings, allowing designation of multiple systems. However, in such an approach, each device would be specified in the audience claim, increasing the size of the token. The increase in token size leads to computational overhead and a performance impact for the target devices. Additionally, the list of target devices must be maintained by either the authorization server or the client application. When requesting a token, either the client must provide this list, or the authorization server must generate it to populate the audience claim of the token. Thus this solution is also problematic.

Accordingly, embodiments of this disclosure may allow for provisioning of a single token that can be used on a group of multiple management controllers by designating a single group identifier as the audience claim. This may be accomplished in some embodiments without requiring the authorization server to issue a token for each management controller, or requiring the client application to maintain a record of tokens for every management controller.

Accordingly, embodiments of this disclosure may provide improvements that may lessen the configuration burdens noted above in the field of delegated authorization.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with delegated authorization in information handling systems may be reduced or eliminated.

In accordance with embodiments of the present disclosure, an information handling system may include a processor; a memory; and a management controller. The information handling system may be configured to: receive, at the management controller and from a client information handling system, a request for management associated with the management controller; determine an audience claim of a token associated with the request, wherein the audience claim comprises a group identifier, and wherein the group identifier is associated with a plurality of management controllers; and in response to a determination that the management controller is one of the plurality of management controllers with which the group identifier is associated, cause the management controller to service the request.

In accordance with these and other embodiments of the present disclosure, a method may include an information handling system that includes a management controller receiving, at the management controller and from a client information handling system, a request for management associated with the management controller; the information handling system determining an audience claim of a token associated with the request, wherein the audience claim comprises a group identifier, and wherein the group identifier is associated with a plurality of management controllers; and in response to a determination that the management controller is one of the plurality of management controllers with which the group identifier is associated, the information handling system causing the management controller to service the request.

In accordance with these and other embodiments of the present disclosure, an article of manufacture may include a non-transitory, computer-readable medium having computer-executable code thereon that is executable by a processor of an information handling system that includes a management controller for: receiving, at the management controller and from a client information handling system, a request for management associated with the management controller; determining an audience claim of a token associated with the request, wherein the audience claim comprises a group identifier, and wherein the group identifier is associated with a plurality of management controllers; and in response to a determination that the management controller is one of the plurality of management controllers with which the group identifier is associated, causing the management controller to service the request.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIGS. 2A and 2B illustrate block diagrams of an administrator using individual access tokens for each of a plurality of management controllers, in accordance with embodiments of the present disclosure; and

FIGS. 3A and 3B illustrate block diagrams of an administrator using a single access token for each of a plurality of management controllers, in accordance with embodiments of the present disclosure.

### DETAILED DESCRIPTION

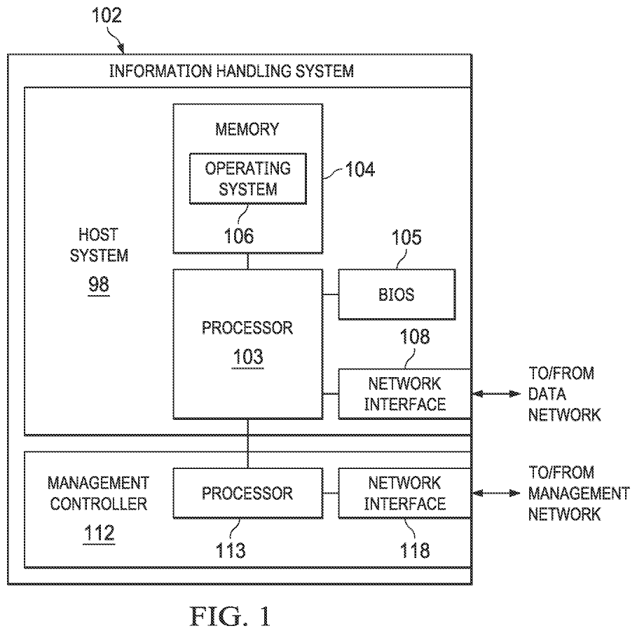

Preferred embodiments and their advantages are best understood by reference to FIGS. 1-3B, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives, solid-state drives, and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

In some embodiments, several information handling systems 102 may be incorporated into a single chassis and/or cluster. Each information handling system 102 may have its own management controller 112 (e.g., a BMC). As discussed above, some delegated authorization systems would require a separate access token for each management controller 112. For the sake of clarity and exposition, examples involving BMC management controllers will be discussed in detail herein. One of ordinary skill in the art with the benefit of this disclosure will understand its applicability to other systems as well, however.

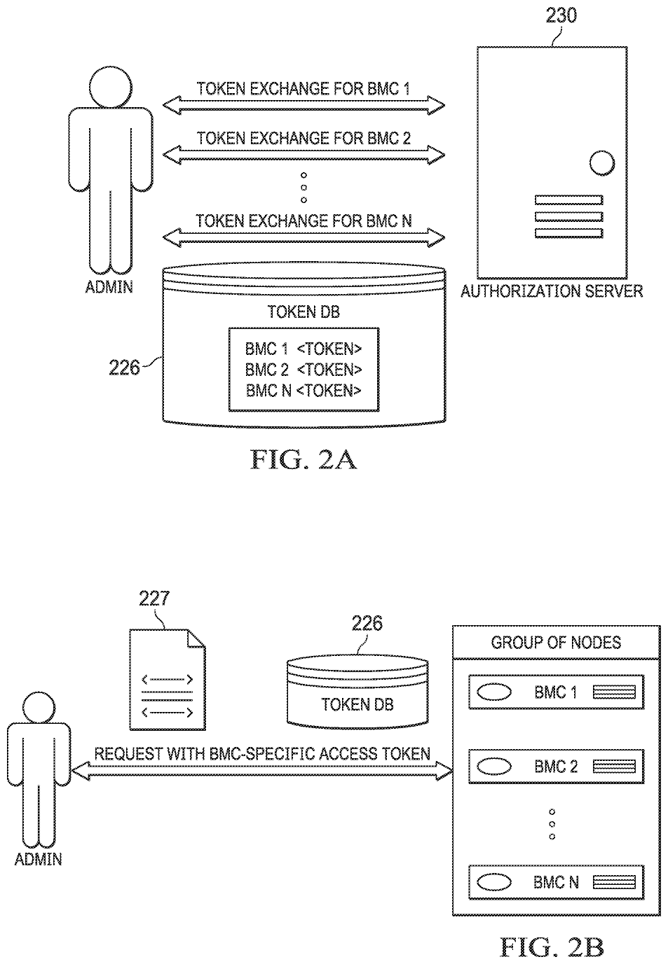

Turning now to FIGS. 2A and 2B, an example is shown in which an administrator has to perform a token exchange for every individual BMC that needs to be accessed. In FIG. 2A, the administrator performs N token exchanges with authorization server 230 for the N BMCs. The resulting tokens (e.g., both the offline tokens and the access tokens) may then be stored in token database 226.

In FIG. 2B, the administrator may use the tokens in token database 226 to access individual ones of the N BMCs. For example, the administrator may look up an IP address (or other identifying information) for the target BMC, obtain a BMC-specific access token 227 from token database 226, and then use the BMC-specific access token 227 to request access to the desired target BMC.

The need to maintain N BMC-specific access tokens for the N target BMCs becomes cumbersome as N grows larger. Accordingly, embodiments of this disclosure may allow for the creation and use of a single token that may be referred to as a “Master Key” token, which can be used on multiple BMCs without requiring the authorization server or the client scripts/applications to keep a token record for every BMC.

The single token may work by programming a common identifier (e.g., a delegated authorization Group ID) for the group of nodes that needs to be accessed. The DA group ID may be unique for the group and may be configured as part of the DA configuration on all the BMCs to be accessed via that group's Master Key token. The Master Key token may contain the DA Group ID as its audience claim, which any BMC in that group may accept as a valid claim in lieu of its own service tag number or MAC address. Additionally, any type of server in a datacenter (e.g., modular, monolithic, etc.) that has DA support may be combined while aggregating a DA Group. Once part of a DA Group, a Master Key token may be used to access any or all the BMCs within that group.

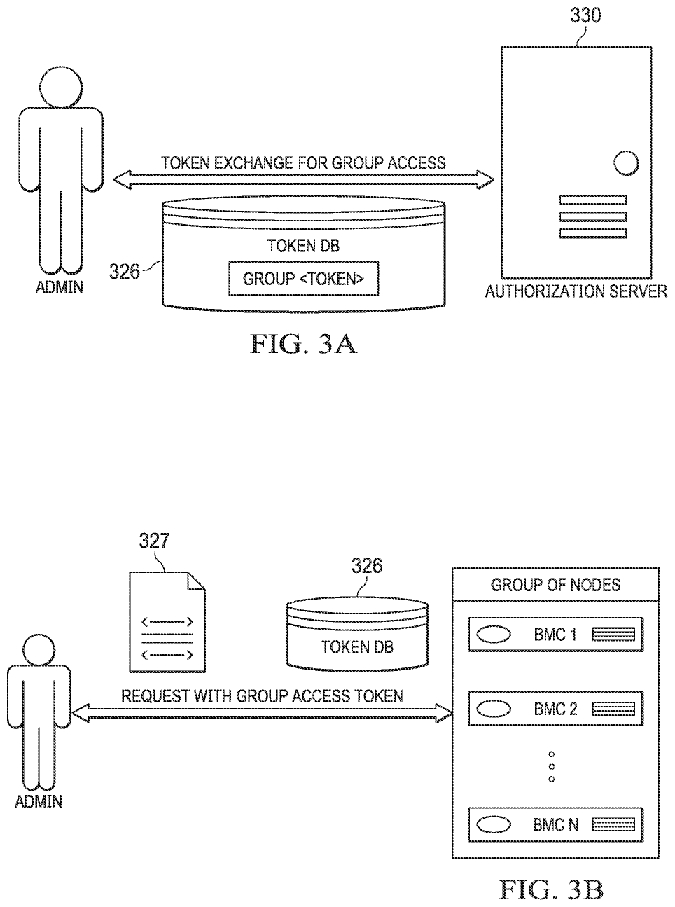

This single Master Key token may also work seamlessly with the normal OAuth 2.0 refresh workflow as illustrated by FIGS. 3A and 3B.

Turning now to FIGS. 3A and 3B, an embodiment is shown in which the administrator is able to perform a similar method in a more convenient manner. In this embodiment, the administrator can obtain a token from authorization server 330 that is valid on all devices within a given designated group. This eliminates the need for the user/application to perform a token refresh for a new individual token prior to accessing each individual BMC. This ‘Master Key’ token can still provide individualized device privileges as needed. Token database 326 is shown as storing the group token(s), but in some embodiments a token database may not even be needed due to the reduced number of tokens compared with FIGS. 2A and 2B.

In the following example, a group-level token payload is shown that may be used for BMCs in a Group designated in the audience claim “aud” as “Location1”, wherein User “Admin” has the “admin” role on all BMCs in the group (note the wildcard character).

{
“xidp”: {
“*”: [“L”,“CD”,“CU”,“CL”,“SC”,“AR”,“VM”,“TA”,“DC”]
},
“sub”: “Admin”,
“iss”: “Authorization_Server_1”,
“exp”: 1607436878,
“aud”: “Location1”
}

Such a token would be useful in a situation where an administrator wants to access every BMC using a single token. This would facilitate single-credential access and simplify initial deployment or global configuration.

It is also possible to create a Master Key token with individualized BMC privileges. In the following example, a group-level token payload may be used for BMCs in a Group designated as “subLevel1”, wherein User “User1” has login only to the group, and admin on BMC1.

{
“xidp”: {
“*”: [“L”],
“BMC1”: [“CD”,“CU”,“CL”,“SC”,“AR”,“VM”,“TA”,“DC”]
},
“sub”: “ User1”,
“iss”: “Authorization_Server_1”,
“exp”: 1607436878,
“aud”: “subLevel1”
}

In general, the group identifier specified in the audience claim may be a number, a character string, or any other suitable identifier. The use of a single identifier is to be distinguished from the situation in which an array or list of individual identifier is specified in the audience claim.

User-based access revocation or privilege modification may also be easily handled according to embodiments of this disclosure. Since the access tokens may have a short expiry and need to be refreshed, any updates to a user's privileges may be quickly handled as part of the normal OAuth 2.0 refresh cycle.

Embodiments may simplify workflows by eliminating the need of individual token management. By using Master Key tokens, users can access any BMC within a group, without the need to maintain a list of BMC-specific tokens. This single token may still be protected by the authorization server's signature, and thus cannot be modified by users to escalate their own privileges. Use of a group name also simplifies the token processing within the BMC, as compared to processing a potentially long list of BMCs in the audience claim.

Embodiments may be extended to multiple groups such that BMCs can be part of a primary group as well as one or more secondary groups. By creating logical subgroups, users can configure customized access to these BMCs.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
a processor;
a memory; and
a management controller;
wherein the information handling system is configured to:
receive, at the management controller and from a client information handling system, a request for management associated with the management controller;
determine an audience claim of a token associated with the request, wherein the audience claim comprises a group identifier, and wherein the group identifier is associated with a plurality of management controllers; and
in response to a determination that the management controller is one of the plurality of management controllers with which the group identifier is associated, cause the management controller to service the request.

2. The information handling system of claim 1, wherein the access token is a JavaScript Object Notation (JSON) Web Token (JWT).

3. The information handling system of claim 1, wherein the plurality of management controllers comprises a plurality of baseboard management controllers (BMCs).

4. The information handling system of claim 1, further configured to validate the token by transmitting a request to an external authorization server.

5. The information handling system of claim 1, wherein the group identifier is a number and/or a character string.

6. The information handling system of claim 1, wherein the audience claim does not include a unique identifier for any of the plurality of management controllers.

7. A method comprising:
an information handling system that includes a management controller receiving, at the management controller and from a client information handling system, a request for management associated with the management controller;
the information handling system determining an audience claim of a token associated with the request, wherein the audience claim comprises a group identifier, and wherein the group identifier is associated with a plurality of management controllers; and
in response to a determination that the management controller is one of the plurality of management controllers with which the group identifier is associated, the information handling system causing the management controller to service the request.

8. The method of claim 7, wherein the access token is a JavaScript Object Notation (JSON) Web Token (JWT).

9. The method of claim 7, wherein the plurality of management controllers comprises a plurality of baseboard management controllers (BMCs).

10. The method of claim 7, further comprising:
validating the token by transmitting a request to an external authorization server.

11. The method of claim 7, wherein the group identifier is a number and/or a character string.

12. The method of claim 7, wherein the audience claim does not include a unique identifier for any of the plurality of management controllers.

13. An article of manufacture comprising a non-transitory, computer-readable medium having computer-executable code thereon that is executable by a processor of an information handling system that includes a management controller for:
receiving, at the management controller and from a client information handling system, a request for management associated with the management controller;
determining an audience claim of a token associated with the request, wherein the audience claim comprises a group identifier, and wherein the group identifier is associated with a plurality of management controllers; and
in response to a determination that the management controller is one of the plurality of management controllers with which the group identifier is associated, causing the management controller to service the request.

14. The article of claim 13, wherein the access token is a JavaScript Object Notation (JSON) Web Token (JWT).

15. The article of claim 13, wherein the plurality of management controllers comprises a plurality of baseboard management controllers (BMCs).

16. The article of claim 13, wherein the code is further executable for:
validating the token by transmitting a request to an external authorization server.

17. The article of claim 13, wherein the group identifier is a number and/or a character string.

18. The article of claim 13, wherein the audience claim does not include a unique identifier for any of the plurality of management controllers.
